(19) United States
(12) Patent Application Publication
(10) Pub. No.: US 2008/0095153 A1
(43) Pub. Date: Apr. 24, 2008

(54) APPARATUS AND COMPUTER PRODUCT FOR COLLECTING PACKET INFORMATION

(75) Inventors: Hideyo Fukunaga, Fukuoka (JP); Takeshi Miyaura, Fukuoka (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 11/872,344

(22) Filed: Oct. 15, 2007

(30) Foreign Application Priority Data
Oct. 19, 2006 (JP) 2006-285543

(51) Int. Cl. H04L 12/56

(52) U.S. Cl. 370/389

(57) ABSTRACT

A connection-basis identification information storing unit receives connection-basis identification information for identifying a packet for which information on the packet is to be collected, and stores received connection-basis identification information. A connection-basis packet information collecting unit acquires the information receives stores if a packet that is identified by the stored connection-basis identification information is received, and stores acquired information in a predetermined storage unit on the basis of the connection identified by a combination of a transmission source address and a transmission destination address included in the packet.

### BACKGROUND OF THE INVENTION

1. Field of the Invention

The invention relates to an apparatus and a computer product for collecting packet information.

2. Description of the Related Art

Conventionally, a packet information collecting apparatus that collects information about packets transmitted over a network has been utilized by operation managers or the like who operates a network, for the purpose of capacity planning of the network or segmentation at the time of failure. Recently, the utilization of the packet information collecting apparatus attracts attention because of the additional purposes such as stable operation of a network and prevention of failure occurrence (e.g., prevention of slowing down of a server due to abnormal traffics and system down due to attacks).

The packet information collecting apparatus collects information preliminarily specified by a user policy (such as statistical information about how many and what packets have been transmitted from what terminal), etc. For example, the packet information collecting apparatus includes a hard logic that identifies a packet preliminarily specified by a user policy (such as a packet specified by what packet is transmitted from what terminal), uses the hard logic to determine whether a packet transferred over the network is the specified packet, and collects information about the packet (such as how many packets are transmitted).

For example, Japanese Patent Application Laid-Open Publication No. H10-23011 has disclosed a technique of detecting preliminarily specified information (failure notification using AIS (Alarm Indication Signal)/RDI (Remote Defect Indication)) with a circuit interface, temporarily storing the information into a memory of a circuit board, and transferring a statistical value of the information from the circuit board to a control unit in a packet information collecting apparatus.

However, in the above conventional technology, it is problematic that changes in the specification of information to be collected cannot flexibly be accommodated. That is, to accommodate changes in the specification in the technique including the hard logic identifying a packet, the hard logic must be configured on a large scale, which cannot flexibly be supported. Alternatively, to accommodate changes in the specification in the technique of detecting the failure notification using AIS/RDI with a circuit interface, a circuit interface capable of detecting other types of information must be introduced, which also cannot flexibly be supported.

To solve these problems, a technique has been proposed to store in a storage unit the specification of information to be collected (see Patent Application No. 2005-509468 filed by the same applicant as the present invention). Specifically, in the proposed technique, a packet information collecting apparatus stores identification information of a packet specified by a user policy in the storage unit and stores statistical information of packet identified by the identification information for each packet when receiving a packet transferred over a network (stores statistical information having a transmission source address or transmission destination address identified). With the proposed technique, changes in the specification of information to be collected can flexibly be accommodated since only the identification information stored in the storage unit must be changed when changing the specification of information to be collected.

However, it is problematic in this proposed technique that connection-basis information (information having an identified combination of a transmission source address and a transmission destination address) cannot be collected. That is, in this proposed technique, the connection-basis information cannot be collected since the statistical information of packets identified by the identification information is stored for each packet having a transmission source address or transmission destination address identified.

### SUMMARY OF THE INVENTION

It is an object of the present invention to at least partially solve the problems in the conventional technology.

A packet information collecting apparatus according to one aspect of the present invention receives a packet transmitted from a transmission source address to a transmission destination address and collects information on the packet. The packet information collecting apparatus includes a connection-basis identification information storing unit that receives connection-basis identification information for identifying a packet for which the information is to be collected on the basis of a connection specifying a combination of the transmission source address and the transmission destination address from a predetermined input unit, and stores received connection-basis identification information; and a connection-basis packet information collecting unit that acquires the information if a packet that is identified by the connection-basis identification information is received, and stores acquired information in a predetermined storage unit on the basis of the connection identified by a combination of the transmission source address and the transmission destination address included in the packet.

A computer-readable recording medium according to another aspect of the present invention stores therein a computer program for receiving a packet transmitted from a transmission source address to a transmission destination address and collects information on the packet. The computer program causes a computer to execute connection-basis identification information storing including receiving connection-basis identification information for identifying a packet for which the information is to be collected on the basis of a connection specifying a combination of the transmission source address and the transmission destination address from a predetermined input unit, and storing received connection-basis identification information; and connection-basis packet information collecting including acquiring the information if a packet that is identified by the connection-basis identification information is received, and storing acquired information in a predetermined storage unit on the basis of the connection identified by a combination of the transmission source address and the transmission destination address included in the packet.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating outline and feature of a packet information collecting apparatus according to a first embodiment of the present invention;

FIG. 2 is a block diagram of a configuration of the packet information collecting apparatus according to the first embodiment;

FIG. 3 is a schematic diagram of a table A in a pattern extracting unit;

FIG. 4 is a schematic diagram of a table C in a pattern searching unit;

FIG. 5 is a schematic diagram for illustrating a packet-basis information collection;

FIG. 6 is a schematic diagram for illustrating a connection-basis information collection;

FIG. 7 is a schematic diagram of a memory map example of a statistical information memory B;

FIG. 8 is a schematic diagram of a packet example 1;

FIG. 9 is a schematic diagram of a packet example 2;

FIG. 10 is a flowchart of a packet information collecting process (packet-basis) according to the first embodiment;

FIG. 11 is a flowchart of a packet information collecting process (connection-basis) according to the first embodiment; and

FIG. 12 is a block diagram of a computer executing a packet information collecting program.

### DETAILED DESCRIPTION OF THE PREFERRED EMBODIMENTS

Exemplary embodiments of the present invention are described in detail below with reference to the accompanying drawings. Descriptions about key terms used in the embodiments, outline and feature of a packet information collecting apparatus according to a first embodiment, configuration and process procedure of the packet information collecting apparatus according to the first embodiment, and effect of the first embodiment are given in sequence, and other embodiments are then described.

A “packet” used in the following embodiments is a data cluster that is data transmitted/received between apparatuses (data utilized by a higher-order application) with other information added (e.g., transmission source address or transmission destination address). That is, when transmitting/receiving data between the apparatuses, data are generally divided into a plurality of pieces by a predetermined size, and the transmission of the divided data to a transmission destination apparatus requires control information such as an address of a transmission source apparatus (transmission source address), an address of a transmission destination apparatus (transmission destination address), a transmission source port number, and a transmission destination port number in the case of communication using TCP (Transmission Control Protocol). Therefore, the “packet” having such control information added is used to transmit/receive data between the apparatuses.

However, since the “packet” has various pieces of control information in addition to the data utilized by the higher-order application as described above, if a “packet information collecting apparatus” collects information focusing on the control information as “information about the packet”, collected information can subsequently be utilized for analysis of communication status of a certain transmission source address (transmission source apparatus).

The information collected as the “information about the packet” by the “packet information collecting apparatus” can be utilized in many scenes, and the collection of the “information about the packet” is considered useful not only for capacity planning of a network or segmentation at the time of failure but also for stable operation of a network and prevention of failure occurrence, and is attracting attention of operation managers who operate the network. Since the number and types of “packets” transferred over a network are enormous, simply collecting all the pieces of the “information about the packet” does not work. It is important to suitably collect necessary information in accordance with a purpose of operation/management of the network. Particularly, since the “packets” are transmitted/received between the apparatuses, it is very meaningful to collect packets on the basis of a connection having an identified combination of the “transmission source address” and the “transmission destination address”.

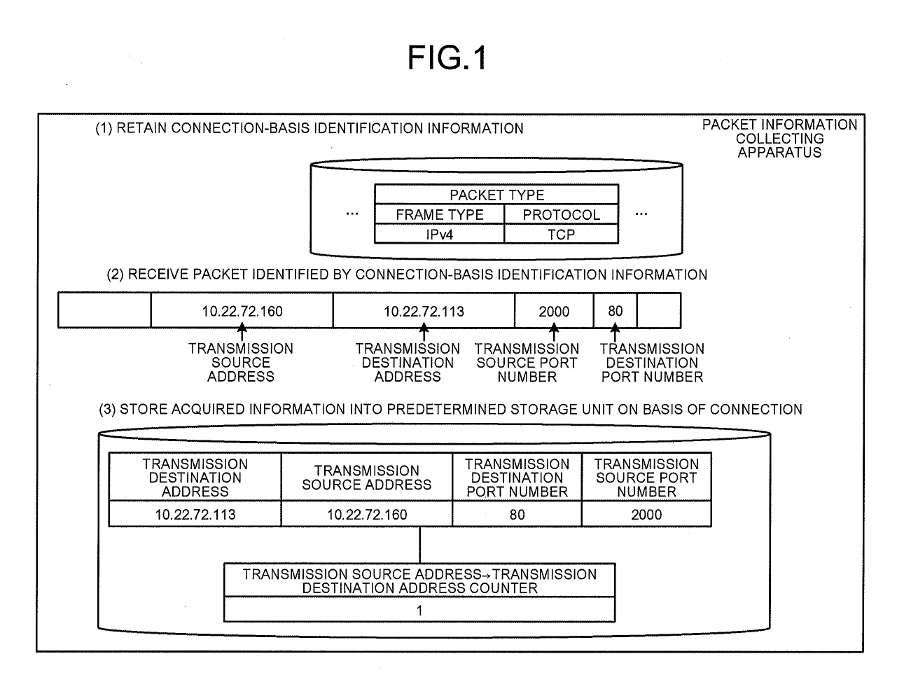

FIG. 1 is a schematic diagram illustrating outline and feature of the packet information collecting apparatus according to the first embodiment. The packet information collecting apparatus is applicable to any configuration that receives packets to collect information about the packets, such as a configuration connected to a backbone of a network that is a target of information collection to receive packets, and a configuration connected between a web server released to public and the Internet to receive packets accessing the web server.

The outline of the packet information collecting apparatus according to the first embodiment is to receive a packet transmitted from a transmission source address to a transmission destination address to collect information about a packet as described above, and a main feature thereof is to collect the connection-basis information and to flexibly accommodate a change in the specification of information to be collected.

Briefly describing this main feature, as shown in FIG. 1, the packet information collecting apparatus according to the first embodiment receives connection-basis identification information (information for identifying a packet that is a target of information collection on the basis of a connection having an identified combination of a transmission source address and a transmission destination address) from a predetermined input unit and stores received information (see (1) of FIG. 1). For example, the packet information collecting apparatus receives information specifying a packet type (frame type “IPv4 (Internet Protocol version 4)”, protocol “TCP (Transmission Control Protocol)”) for the connection-basis identification information from the input unit such as a keyboard and stores received information as shown in (1) of FIG. 1.

Although FIG. 1 illustrates a technique of storing the information specifying a packet type for the connection-basis identification information, this is not a limitation of the present invention, and any types and combinations of stored information may be used in a technique of storing information specifying an error type, a technique of storing other control information, etc., as long as the information is identification information for identifying a packet that is a target of information collection.

As shown in FIG. 1, the packet information collecting apparatus according to the first embodiment acquires information when receiving a packet identified by the connection-basis identification information (see (2) of FIG. 1) and stores the acquired information into a predetermined storage unit on the basis of a connection identified by a combination of a transmission source address and a transmission destination address included in the packet (see (3) of FIG. 1).

For example, when receiving a packet including a transmission source address “10.22.72.160”, a transmission destination address “10.22.72.113”, a transmission source port number “2000”, a transmission destination port number “80”, etc., as shown in (2) of FIG. 1 as a packet identified by the connection-basis identification information, the packet information collecting apparatus acquires information that is a count of a packet transmitted from the transmission source address “10.22.72.160” to the transmission destination address “10.22.72.113” and stores the acquired count in the storage unit on the basis of a connection identified by the combination the transmission source address “10.22.72.160” and the transmission destination address “10.22.72.113” as shown in (3) of FIG. 1.

Although the acquired information is a count of a packet transmitted from a certain transmission source address to a certain transmission destination address in the example shown in FIG. 1, this is not a limitation of the present invention, and for example, the present invention is also applicable to a case of acquiring other information such as other statistical information about a packet, status information about a packet, and a sequence number of a packet.

As a result, the packet information collecting apparatus according to the first embodiment can collect the connection-basis information and can flexibly accommodate changes in the specification of information to be collected. That is, since the information about the packet identified by the connection-basis identification information is stored on the basis of the connection having an identified combination of a transmission source address and a transmission destination address in the packet information collecting apparatus according to the first embodiment, the connection-basis information can be collected, and since only changes in the connection-basis identification information must be received and stored with a predetermined input unit when changing the specification of information to be collected (changing the user policy) in the packet information collecting apparatus according to the first embodiment, the changes in the specification of information to be collected can flexibly be accommodated.

The packet information collecting apparatus according to the first embodiment is characterized not only by the above main feature but also in that the predetermined storage unit is partitioned for each piece of information about a packet identified by any one or more of the transmission source address, the transmission destination address, the transmission source port number, and the transmission destination port number to store the acquired information within a relevant partition. The packet information collecting apparatus according to the first embodiment is also characterized in that the information stored in the storage unit is correlated with information about a reverse-direction packet (a packet having a transmission source address and a transmission destination address reversed). The packet information collecting apparatus according to the first embodiment is also characterized in that the storage unit also stores information on the basis of a packet having a transmission source address or transmission destination address identified.

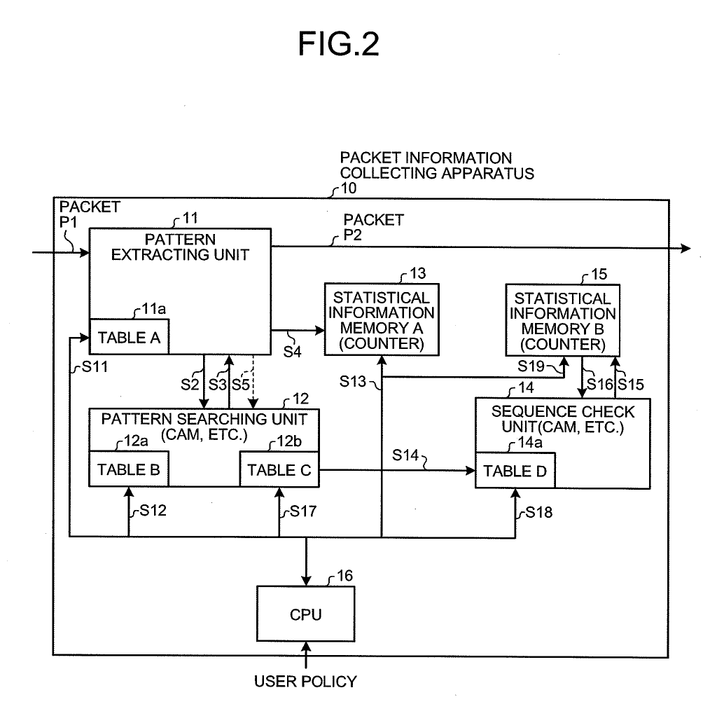

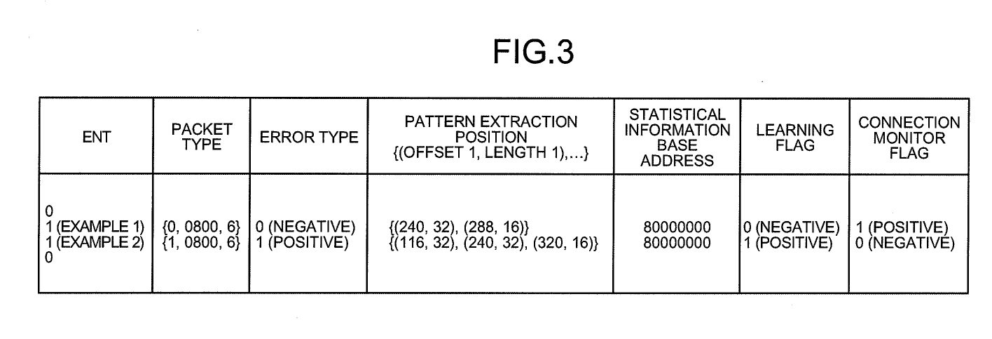

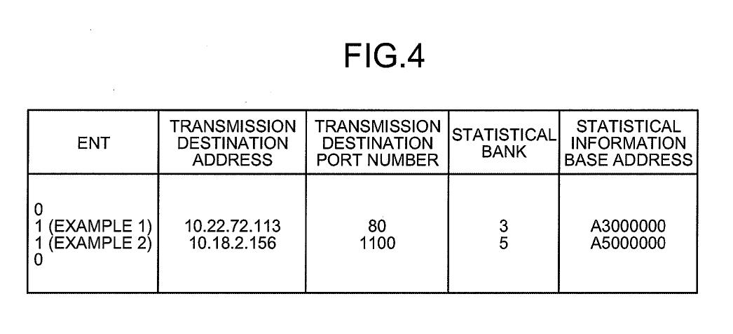

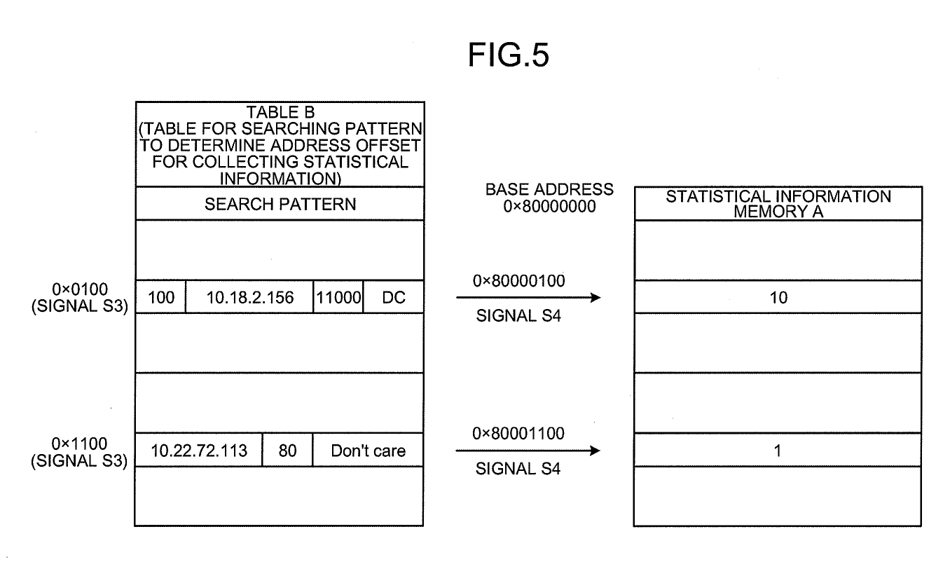

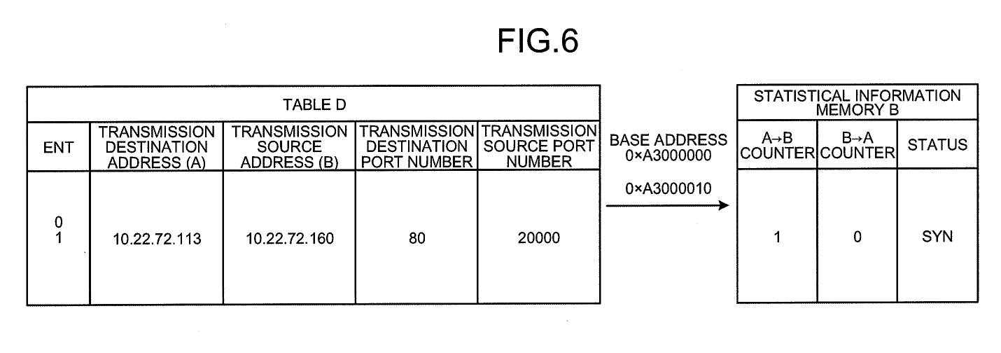

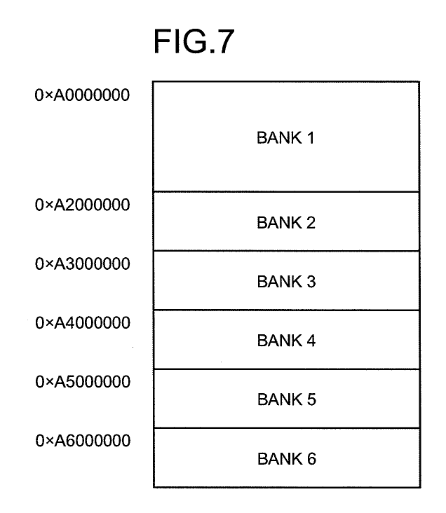

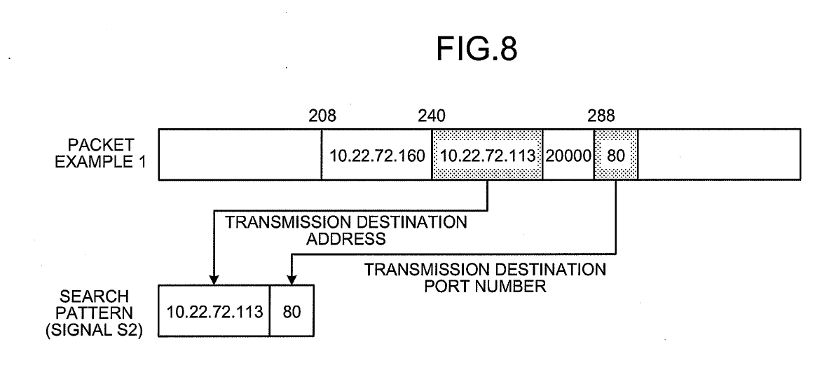

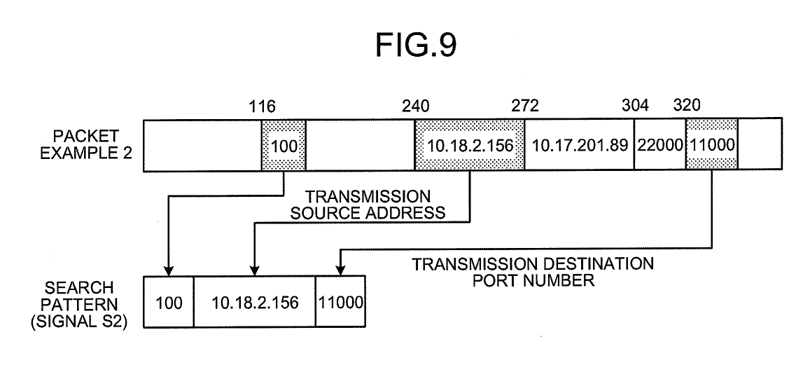

The configuration of the packet information collecting apparatus according to the first embodiment will be described with reference to FIGS. 2 to 9. FIG. 2 is a block diagram of a configuration of the packet information collecting apparatus according to the first embodiment; FIG. 3 is a schematic diagram of a table A in a pattern extracting unit; FIG. 4 is a schematic diagram of a table C in a pattern searching unit; FIG. 5 is a schematic diagram for illustrating a packet-basis information collection; FIG. 6 is a schematic diagram for illustrating a connection-basis information collection; FIG. 7 is a schematic diagram of a memory map example of a statistical information memory B; FIG. 8 is a schematic diagram of a packet example 1; and FIG. 9 is a schematic diagram of a packet example 2.

As shown in FIG. 2, a packet information collecting apparatus 10 according to the first embodiment particularly includes constituent elements closely related to the present invention: a pattern extracting unit 11; a pattern searching unit 12; a statistical information memory A 13; a sequence check unit 14; and a statistical information memory B 15. The pattern extracting unit 11 includes a table A 11a. The pattern searching unit 12 includes a table B 12a and a table C 12b. The sequence check unit 14 includes a table D 14a.

The packet information collecting apparatus 10 according to the first embodiment is assumed to have a configuration that can collect not only the connection-basis information but also the packet-basis information and that can specify whether the connection-basis information is collected when collecting the packet-basis information.

The table A 11a of the pattern extracting unit 11 corresponds to a “packet-basis identification information storing unit” and a “connection-basis identification information storing unit” set forth in the claims. The pattern extracting unit 11, the pattern searching unit 12, and the statistical information memory A 13 are correspond to a “packet-basis packet information collecting unit” set forth in the claims. The pattern extracting unit 11, the pattern searching unit 12, the sequence check unit 14, and the statistical information memory B 15 correspond to a “connection-basis packet information collecting unit” set forth in the claims.

In the packet information collecting apparatus 10, the table A 11a and the table C 12b are a storage unit that stores a user policy input by a network operation manager, etc. Therefore, the table A 11a and the table C 12b preliminarily stores a user policy in principle before the packet information collecting process of the packet information collecting apparatus 10.

The table A 11a stores packet-basis identification information (information for identifying a packet that is a target of information collection on the basis of a packet) and connection-basis identification information (information for identifying a packet that is a target of information collection on the basis of a connection) as one of the user policy. That is, since the packet information collecting apparatus 10 according to the first embodiment is assumed to have the above configuration that can collect not only the connection-basis information but also the packet-basis information, the table A 11a stores both the packet-basis identification information and the connection-basis identification information.

Since the packet information collecting apparatus 10 according to the first embodiment is assumed to have the above configuration that can specify whether the connection-basis information is collected when collecting the packet-basis information, the table A 11a stores the connection-basis identification information such that specification information (“a connection monitor flag” described later) is stored to specify whether a target packet of the packet-basis information collection is defined as a target of the connection-basis information collection and is correlated with the packet-basis identification information.

Specifically describing the table A 11a, the table A 11a receives and stores the identification information for identifying a packet that is a target of information collection on the basis of a packet or connection with the input unit (e.g., a keyboard and a communicating unit), and the stored identification information is utilized for the process of the pattern extracting unit 11. As described above, the identification information stored in the table A 11a is the user policy input by a network operation manager, etc. Therefore, the packet information collecting apparatus 10 according to the first embodiment preliminarily receives the identification information and stores the received identification information in the table A 11a before the packet information collecting process. When changing the specification of information to be collected (changing the user policy), the identification information stored in the table A 11a is changed.

For example, as shown in FIG. 3, the table A 11a correlates and stores “ENT”, “packet type”, “error type”, “pattern extraction position”, “statistical information base address”, “learning flag”, and “connection monitor flag” as the identification information. Although the above pieces of the information are correlated and stored as the identification information in the table A 11a in the description of the first embodiment, this is not a limitation of the present invention, and any combinations of pieces of the stored information or any specific information contents may be used as long as the information identifies a packet that is a target of information collection on the basis of a packet or connection.

Individually describing each item, the “ENT” is an item indicating an entry of the identification information; “0” indicates that an entry does not exist; and “1” indicates that an entry exists. In FIG. 3, the identification information for identifying a packet example 1 described later is indicated by an entry of “(example 1)” and the identification information for identifying a packet example 2 described later is indicated by an entry of “(example 2)”.

The “packet type” is an item indicating “{presence of tag, type value, protocol value}”. The “{presence of tag}” is “1” when identifying a packet having a tag identifier value “8100” set in a predetermined field and is “0” when identifying other packets. The “{type value}” is “800” when identifying a packet having a frame type of “IPv4”. The “{protocol value}” is “6” when identifying a packet using a protocol of “TCP”. The “error type” is “1” when identifying a packet having TTL (Time To Live) of “00” (packet having an error) and “0” when identifying other packets (packets without an error).

The “pattern extraction position” is an item indicating an extraction position for generating a search pattern identifying a specific packet that is a target of information collection (a packet having not only the “packet type” and the “error type” identified but also information such as the transmission source address and the transmission destination address identified) and is represented by correlating an “offset” (value of a position represented by a difference from a reference point) with a “length”. For example, “(240, 32)” indicates that data (e.g., transmission source address) having a length of 32 bits (4 bytes) are extracted as a search pattern from a position 240 bits (30 bytes) away from a reference position.

The “statistical information base address” is an item indicating a base address (reference point of address in a segment mode) in the statistical information memory A 13. The “learning flag” is “1” when newly registering into the table B 12a a packet identified by the identification information and causing a search failure in the search of the table B 12a with the pattern searching unit 12 and is “0” when terminating the process without registering the packet into the table B 12a.

The “connection monitor flag” is an item specifying whether a target packet of the packet-basis information collection is defined as a target of the connection-basis information collection. For example, since information is collected on the basis of a connection of the TCP connection in the case described in the first embodiment, the “connection monitor flag” is “1” when the packet is defined as a target of information collection on the basis of a connection of the TCP connection and is “0” when the packet is not defined as a target of collection. Although the connection-basis information collection in the case of the TCP connection is described in the first embodiment, this in not a limitation of the present invention, and the present invention is also applicable to the connection-basis information collection in other protocols.

The table C 12b stores information for collecting the connection-basis information in a certain partitioned storage unit (e.g., information for collecting in a certain memory bank the connection-basis information used in HTTP communication to a certain server) as one of the user policy. Specifically, the table C 12b receives and stores with the input unit (e.g., a keyboard and a communicating unit) the information that correlates information for identifying a packet by any one or more of the transmission source address, the transmission destination address, the transmission source port number, and the transmission destination port number with information about the partitioning of the storage unit, and the stored information is utilized for the process of the pattern searching unit 12. As described above, the information stored in the table C 12b is the user policy input by the network operation manager, for example. Therefore, the packet information collecting apparatus 10 according to the first embodiment preliminarily receives and stores the above information in the table C 12b before the packet information collecting process.

Specifically describing the information stored in the table C 12b with an example, as shown in FIG. 4, the table C 12b stores and correlates “ENT”, the information for identifying a packet that is “transmission source address” and “transmission source port number”, and the information about the partitioning of the storage unit that is “statistical BANK” and “statistical information base address”. The “BANK” of the “statistical BANK” is a so-called memory bank (a unit used when a memory controller manages a memory). For example, the table C 12b correlates and stores “3” as the “statistical BANK” and “A3000000” as the “statistical information base address”. That is, in the example shown in FIG. 4, it is instructed to collect the connection-basis information of a packet identified by the “transmission destination address” of “10.22.72.113” and the “transmission destination port number” of “80” in the memory bank having the “statistical BANK” of “3”. Although the “transmission destination address” and the “transmission destination port number” are stored for the information for identifying a packet in the case described in the first embodiment, this is not a limitation of the present invention, and the present invention is also applicable to the case of storing other information, for example, storing the “transmission source address” and the “transmission source port number” for the information for identifying a packet.

In the first embodiment, the statistical information memory B 15 is partitioned for each piece of information about the packet identified by any one or more of the transmission source address, the transmission destination address, the transmission source port number, and the transmission destination port number as described later, and since the sequence check unit 14 described later store the information to be stored in the statistical information memory B 15 on the basis of a connection into a partition identified by any one or more of the transmission source address, the transmission destination address, the transmission source port number, and the transmission destination port number in the statistical information memory B 15, the table C 12b stores the “statistical BANK” and the “statistical information base address”. However, this is not a limitation of the present invention, and any forms suitable for network operation and management may be used, such as storing no specific information in the table C 12b when the statistical information memory B 15 is not partitioned.

In the packet information collecting apparatus 10 according to the first embodiment, the table B 12a and the table D 14a registers a search pattern identifying a specific packet that is a target of information collection (a packet having not only the “packet type” and the “error type” but also information such as the transmission source address and the transmission destination address identified) in the course of the packet information collecting process and stores and correlates the search pattern with an “address offset” described later. Therefore, at the start of operation of the packet information collecting apparatus 10, the table B 12a and the table D 14a stores no search pattern. The table B 12a and the table D 14a will hereinafter be described.

The table B 12a stores and correlates the search pattern identifying the specific packet that is a target of information collection with the “address offset” (information determining a “memory access address” when storing information into the statistical information memory A 13). The packet-basis information is stored into the statistical information memory A 13 in the packet information collecting apparatus 10 and is stored at an address specified by the “memory access address” calculated from (by adding) the “statistical information base address” stored in the table A 11a and a “hit address” transmitted from the pattern searching unit 12 to the pattern extracting unit 11. The “address offset” stored in the table B 12a determines this “hit address”.

That is, for example, if the “learning flag” of the identification information stored in the table A 11a is set to “1”, the table B 12a registers and correlates the search pattern generated by the pattern extracting unit 11 with the “address offset” and transmits this “address offset” as the “hit address” to the pattern searching unit 12.

Specifically describing the “address offset” stored in the table B 12a with an example, as shown in FIG. 5, the “address offset” and the search pattern are correlated and stored. For example, the table B 12a stores and correlates the “address offset” of “0x1100” and the search pattern of “10.22.72.113, 80”.

The table D 14a stores and correlates the search pattern identifying a specific packet that is a target of information collection with the “address offset” (information determining a “memory access address” when storing information into the statistical information memory B 15). As is the case with the packet-basis information, the connection-basis information is stored into the statistical information memory B 15 in the packet information collecting apparatus 10 and is stored at an address specified by the “memory access address” calculated from (by adding) the “statistical information base address” stored in the table C 12b and a “hit address” transmitted from the sequence check unit 14. The “address offset” stored in the table D 14a determines this “hit address”.

That is, the table D 14a registers and correlates the pattern configured by a TCP connection identification element with the “address offset” and transmits this “address offset” as the “hit address” to the sequence check unit 14.

In the packet information collecting apparatus 10 according to the first embodiment, the statistical information memory A 13 and the statistical information memory B 15 then stores the collected information. The statistical information memory A 13 and the statistical information memory B 15 will hereinafter be described.

The statistical information memory A 13 stores the packet-basis information. Specifically, the statistical information memory A 13 receives the packet-basis information and the “memory access address” from the pattern extracting unit 11 (see signal S4 shown in FIG. 2) and stores the packet-basis information into the storage unit specified by the received “memory access address”. For example, as shown in FIG. 5, the statistical information memory A 13 receives the “memory access address” of “0x80001100” from the pattern extracting unit 11 and stores the packet-basis information (e.g., statistical information “1”) at an address specified by the received “0x80001100”.

The statistical information memory B 15 stores the connection-basis information. Specifically, the statistical information memory B 15 receives the connection-basis information and the “memory access address” from the sequence check unit 14 (see signal S15 shown in FIG. 2) and stores the connection-basis information into the storage unit specified by the received “memory access address”. For example, as shown in FIG. 6, the statistical information memory B 15 receives the “memory access address” of “0xA3000010” from the sequence check unit 14 and stores the connection-basis information (e.g., statistical information and status) at an address specified by the received “0xA3000010”. As shown in FIG. 7, the statistical information memory B 15 of the first embodiment is partitioned into a plurality of memory banks, and any setting can be performed in the table C 12b with regard to which packet's information is partitioned and stored into which memory bank.

However, although the table A 11a, the table B 12a, the table C 12b, the table D 14a, the statistical information memory A 13, and the statistical information memory B 15 have been described, the pattern extracting unit 11, the pattern searching unit 12, the sequence check unit 14, and a CPU 16 will hereinafter be described as units that transmit/receive signals to/from the above tables and memories to execute the packet information collecting process.

When receiving a packet identified by the identification information, the pattern extracting unit 11 acquires information about the packet and stores the acquired information into the predetermined storage unit on the basis of a packet. Specifically, when the received packet is the packet identified by the identification information stored in the table A 11a, the pattern extracting unit 11 uses the “pattern extraction position” of the identification information to generate the search pattern and transmits the generated search pattern to the pattern searching unit 12 (see signal S2 shown in FIG. 2). If the “connection monitor flag” of the identification information is “1” (if the identification information represents the connection-basis identification information), the pattern extracting unit 11 of the first embodiment extracts the TCP connection identification element (e.g., the transmission source address, the transmission destination address, the transmission source port number, the transmission destination port number, and the TCP flag) from the packet and transmits the TCP connection identification element to the pattern searching unit 12 in addition to the search pattern.

When receiving the “hit address” from the pattern searching unit 12 (see signal S3 shown in FIG. 2), the pattern extracting unit 11 transmits to the statistical information memory A 13 the “memory access address” calculated from (by adding) the “statistical information base address” stored in the table A 11a and the “hit address” (see signal S4 shown in FIG. 2) and stores the information about the packet into the storage unit specified by the “memory access address” on the basis of a packet.

The above search pattern generation in the pattern extracting unit 11 will be described with a specific example. When receiving the packet example 1 shown in FIG. 8, the pattern extracting unit 11 determines that the packet received in this case is identified by the identification information having the “ENT” of “1 (example 1)” from the “packet type” and the “error type” of the identification information stored in the table A 11a. The pattern extracting unit 11 extracts data of (240, 32) and (288, 16) specified by the “pattern extraction position” from the packet example 1 to generate the search pattern. Since the data extracted from the packet example 1 with the offset of 240 and length of 32 are the transmission destination address “10.22.72.113” and the data extracted with the offset of 288 and length of 16 are the transmission destination port number “80” as shown in FIG. 8, the pattern extracting unit 11 links “10.22.72.113” and “80” to generate a pattern, as shown in FIG. 8.

Similarly, when receiving the packet example 2 shown in FIG. 9, the pattern extracting unit determines that the packet received in this case is identified by the identification information having the “ENT” of “1 (example 2)” from the identification information stored in the table A 11a, extracts data specified by the “pattern extraction position” from the packet example 2, and links “10.18.2.156” and “11000” to generate a pattern for the search pattern, as shown in FIG. 9.

The pattern searching unit 12 is configured by CAM (Content Addressable Memory), etc., searches (or registers) the search pattern, and determines the “address offset” (hit address) of the storage unit that stores the information about the packet. When receiving the TCP connection identification element (e.g., the transmission source address, the transmission destination address, the transmission source port number, the transmission destination port number, and the TCP flag, which are extracted from the packet), the pattern searching unit 12 determines the partition of the storage unit that stores the information about the packet.

Specifically, when receiving the search pattern from the pattern extracting unit 11 (see signal S2 shown in FIG. 2), the pattern searching unit 12 searches whether the received search pattern is registered in the table B 12a, and if the pattern is registered, the pattern searching unit 12 transmits to the pattern extracting unit 11 the “address offset” correlated with the search pattern as the “hit address” (see signal S3 shown in FIG. 2). On the other hand, although the search fails if the pattern is not registered, the pattern searching unit 12 registers the received search pattern in the table B 12a in the case of the packet having the “learning flag” of “1” and transmits to the pattern extracting unit 11 the “address offset” correlated with the registered search pattern as the “hit address” (see signal S3 shown in FIG. 2).

When receiving the TCP connection identification element (see signal S2 shown in FIG. 2), the pattern searching unit 12 searches whether the information corresponding to the TCP connection identification element (information for identifying the packet) is registered in the table C 12b, and if the information is registered, the pattern searching unit 12 transmits to the sequence check unit 14 described later the information about the partitioning of the storage unit correlated with the information (e.g., the “statistical BANK” and the “statistical information base address”) and the TCP connection identification element (see signal S14 shown in FIG. 2). If the information for identifying the packet is not registered, for example, only the TCP connection identification element is transmitted to the sequence check unit 14 (see signal S14 shown in FIG. 2) if the partition in the storage unit is preliminary defined for storing unregistered packets.

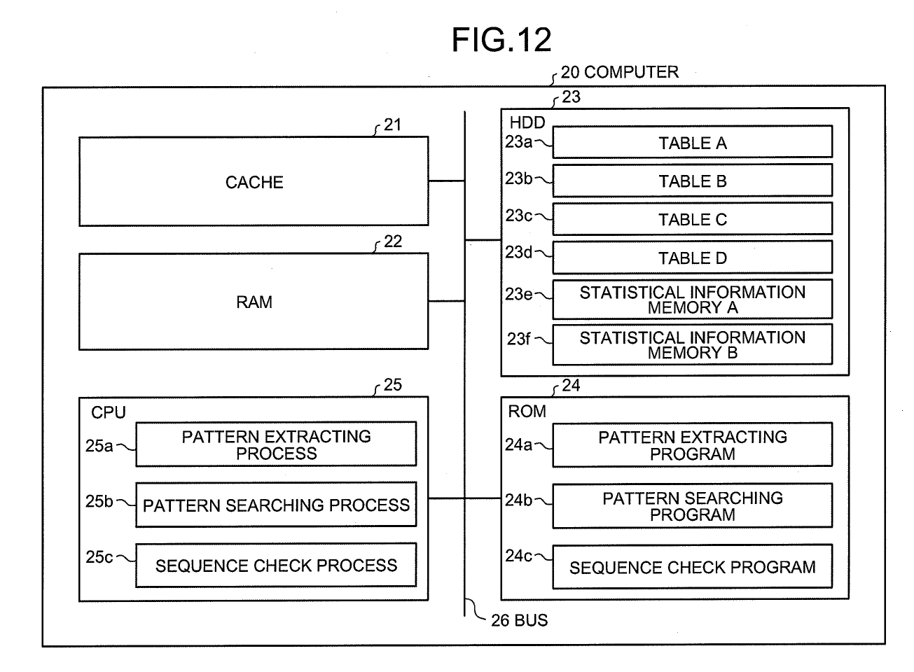

The sequence check unit 14 is configured by CAM, etc., searches the search pattern identifying the specific packet that is a target of information collection (pattern configured by the TCP connection identification element), and determines the “address offset” (hit address) of the storage unit that stores the information about the packet. Specifically, when receiving the TCP connection identification element from the pattern searching unit 12 (see signal S14 shown in FIG. 12), the sequence check unit 14 searches whether the pattern configured by the received TCP connection identification element is registered in the table D 14a, and if the pattern is registered, the sequence check unit 14 transmits to the statistical information memory B 15 the “address offset” correlated with the pattern as the “hit address” (see signal S15 shown in FIG. 2).

On the other hand, although the search fails if the pattern configured by the TCP connection identification element is not registered in the table D 14a, the sequence check unit 14 interchanges the “transmission source address” and the “transmission destination address” and interchanges the “transmission source port number” and the “transmission destination port number” to search the table D 14a again. If the pattern resulted from the interchanging is registered in the table D 14a, the sequence check unit 14 stores and correlates the information about the reverse-direction packet with the information about the packet before the interchanging (information about the forward-direction packet) (e.g., the “hit address” is defined as the “address offset” correlated with the pattern before interchanging the TCP connection identification element).

If the search for the pattern resulted from the interchanging also fails, the sequence check unit 14 newly registers the pattern in the table D 14a and transmits to the statistical information memory B 15 the “address offset” correlated with the registered pattern as the “hit address” (see signal S15 shown in FIG. 2).

The sequence check unit 14 receives, for example, sequence information from the statistical information memory B 15 (see signal S16 shown in FIG. 2), and if a sequence violation occurs as a result of checking the received sequence information against the acquired sequence information, the sequence check unit 14 registers a sequence error into the statistical information memory B (see signal S15 shown in FIG. 2).

The CPU 16 is a control unit that controls the packet information collecting apparatus 10 to execute various processes. For example, when the CPU 16 receives the setting of the user policy from an operation manager, etc., utilizing the packet information collecting apparatus 10, the CPU 16 transmits a signal for setting the user policy in the table A 11a, the table C 12b, etc.

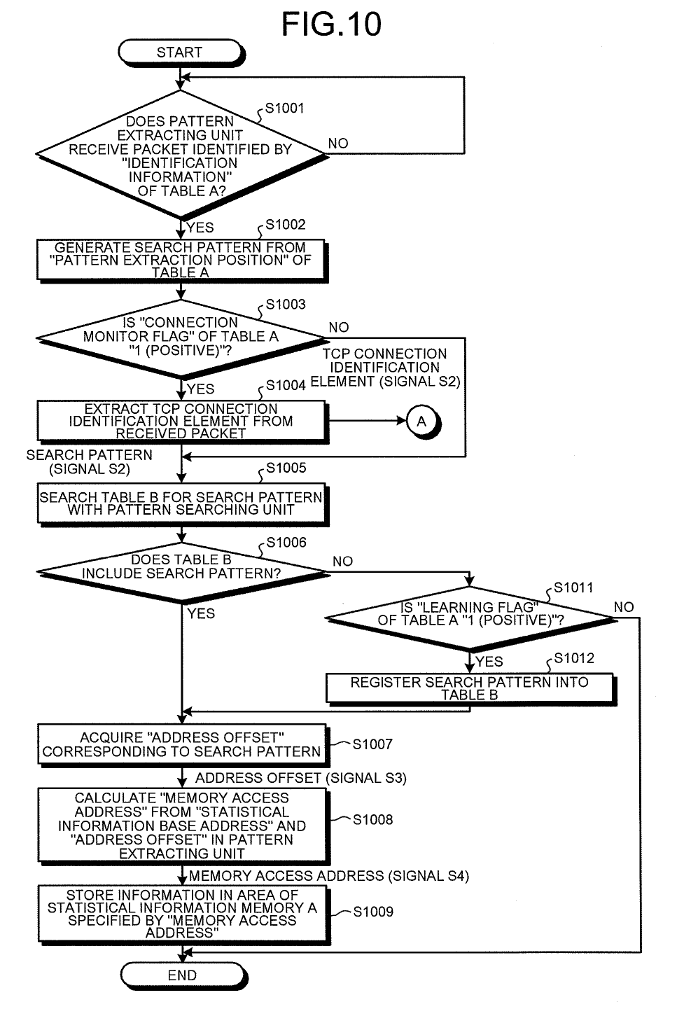

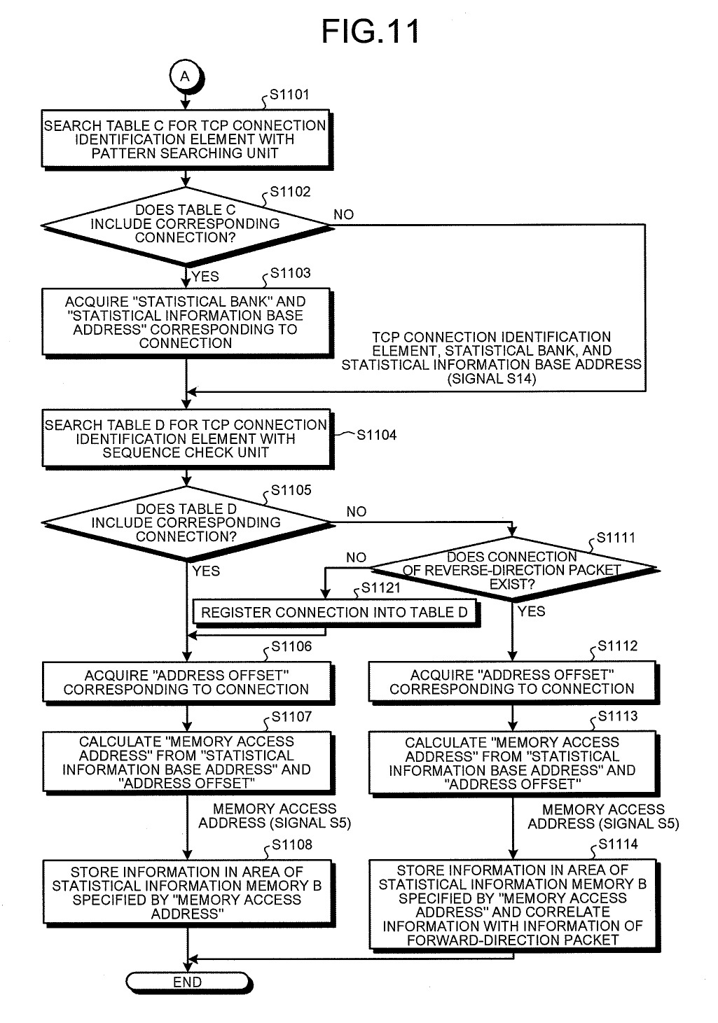

The process of the packet information collecting apparatus according to the first embodiment will be described with reference to FIGS. 10 and 11. FIG. 10 is a flowchart of the packet information collecting process (packet-basis) in the first embodiment, and FIG. 11 is a flowchart of the packet information collecting process (connection-basis) in the first embodiment.

First, the pattern extracting unit 11 of the packet information collecting apparatus 10 determines whether a packet identified by the “identification information” of the table A 11a is received (step S1001). For example, the pattern extracting unit 11 of the packet information collecting apparatus 10 determines whether a received packet is a packet not having a value “8100” of the tag identifier set in a predetermined field (presence of the tag) and having a frame type of “IPv4” (type value), a protocol of “TCP” (protocol value), and TTL other than “00” (error type). If it is not determined that the packet identified by the “identification information” is received (No at step S1001), the packet information collecting apparatus 10 goes back to the process of determining whether the packet identified by the “identification information” is received.

On the other hand, it is determined that the packet identified by the “identification information” is received (Yes at step S1001), the pattern extracting unit 11 of the packet information collecting apparatus 10 generates the search pattern from the “pattern extraction position” of the table A 11a and transmits the generated search pattern to the pattern searching unit 12 (step S1002). For example, the pattern extracting unit 11 of the packet information collecting apparatus 10 extracts the data of (240, 32) and (288, 16) specified by the “pattern extraction position” from the packet and links “10.22.72.113” and “80” to generate a pattern as the search pattern.

The pattern extracting unit 11 of the packet information collecting apparatus 10 determines whether the “connection monitor flag” of the table A 11a is “1 (positive)” (step S1003). If it is not determined that the “connection monitor flag” is “1 (positive)” (No at step S1003), the packet information collecting apparatus 10 goes to a process of step S1005 described later.

On the other hand, if it is not determined that the “connection monitor flag” is “1 (positive)” (Yes at step S1003), the pattern extracting unit 11 of the packet information collecting apparatus 10 extracts the TCP connection identification element from the received packet and transmits the extracted TCP connection identification element to the pattern searching unit 12 (step S1004). For example, the pattern extracting unit 11 of the packet information collecting apparatus 10 extracts from the received packet the TCP connection identification element that is the transmission source address “10.22.72.160”, the transmission destination address “10.22.72.113”, the transmission source port number “20000”, the transmission destination port number “80”, and the TCP flag “SYN”.

Since the process of the packet information collecting apparatus 10 is mainly branched into a “packet-basis information collection process” and a “connection-basis information collection process” after step S1004, the process procedure of the “packet-basis information collection process” will first be described with reference to FIG. 10.

After the step S1004, the pattern searching unit 12 of the packet information collecting apparatus 10 searches the table B 12a for the search pattern transmitted from the pattern extracting unit 11 (step S1005). For example, the pattern searching unit 12 of the packet information collecting apparatus 10 searches the table B 12a for the search pattern formed by linking “10.22.72.113” and “80”.

The pattern searching unit 12 of the packet information collecting apparatus 10 determines whether the table B 12a includes the search pattern (step S1006). If it is determined that the table B 12a includes the search pattern (Yes at step S1006), the pattern searching unit 12 of the packet information collecting apparatus 10 acquires the “address offset” corresponding to the search pattern from the table B 12a and transmits the acquired “address offset” to the pattern extracting unit 11 (step S1007). For example, the pattern searching unit 12 of the packet information collecting apparatus 10 acquires “0x1100” as the “address offset” corresponding to the search pattern from the table B 12a.

The pattern extracting unit 11 of the packet information collecting apparatus 10 then calculates the “memory access address” from the “statistical information base address” of the table A 11a and the “address offset” received from the pattern searching unit 12 (step S1008). For example, the pattern extracting unit 11 of the packet information collecting apparatus 10 adds the “statistical information base address” of “0x80000000” and the “address offset” of “0x1100” to calculate the “memory access address” of “0x80001100”.

The pattern extracting unit 11 of the packet information collecting apparatus 10 stores the packet-basis information in the area of the statistical information memory A 13 specified by the “memory access address” (step S1009). For example, the pattern extracting unit 11 of the packet information collecting apparatus 10 stores the statistical information “1”, etc., as the packet-basis information in the area of the statistical information memory A 13 specified by the “memory access address” of “0x80001100”.

However, if it is not determined that the table B 12a includes the search pattern (No at step S1006), the pattern searching unit 12 of the packet information collecting apparatus 10 determines whether the “learning flag” of the table A 11a is “1 (positive)” (step S1011), and if the “learning flag” is “1 (positive)” (Yes at step S1011), the search pattern is registered into the table B 12a (step S1012) and the packet information collecting apparatus 10 goes to the above process of step S1007. On the other hand, if the “learning flag” is not “1 (positive)” (No at step S1011), the packet information collecting apparatus 10 terminates the process.

The process procedure of the “connection-basis information collection process” will be described with the use of FIG. 11. After the step S1004 shown in FIG. 10, the pattern searching unit 12 of the packet information collecting apparatus 10 searches the table C 12b for the TCP connection identification element (step S1101). For example, the pattern searching unit 12 of the packet information collecting apparatus 10 searches the table C 12b for the TCP connection identification element that is the transmission source address “10.22.72.160”, the transmission destination address “10.22.72.113”, the transmission source port number “20000”, the transmission destination port number “80”, and the TCP flag “SYN”.

The pattern searching unit 12 of the packet information collecting apparatus 10 determines whether the table C 12b includes a corresponding connection (step S1102), and if it is not determined that the connection is included (No at step S1102), the packet information collecting apparatus 10 goes to step S1104 described later since this is the case such that the partition of the storage unit is preliminarily defined for storing the packet.

On the other hand, if it is determined that the connection is included (Yes at step S1102), the pattern searching unit 12 of the packet information collecting apparatus 10 acquires the “statistical BANK” and “statistical information base address” corresponding to the connection from the table C 12b and transmits the TCP connection identification element, the “statistical BANK”, and the “statistical information base address” to the sequence check unit 14 (step S1103). For example, the pattern searching unit 12 of the packet information collecting apparatus 10 acquires the “statistical BANK” of “3” and the “statistical information base address” of “A3000000” corresponding to the connection of the transmission destination address “10.22.71.113” and the transmission destination port number “80” of the TCP identification element.

The sequence check unit 14 of the packet information collecting apparatus 10 searches the table D 14a for the TCP connection identification element (step S1104). For example, the sequence check unit 14 of the packet information collecting apparatus 10 searches the table D 14a for the TCP connection identification element that is the transmission source address “10.22.72.160”, the transmission destination address “10.22.72.113”, the transmission source port number “20000”, the transmission destination port number “80”, and the TCP flag “SYN”.

The sequence check unit 14 of the packet information collecting apparatus 10 determines whether the table D 14a includes a corresponding connection (step S1105), and if the corresponding connection is included (Yes at step S1105), the sequence check unit 14 of the packet information collecting apparatus 10 acquires the “address offset” corresponding to the connection from the table D 14a (step S1106). For example, the sequence check unit 14 of the packet information collecting apparatus 10 acquires “0x1100” as the “address offset” from the table D 14a

The sequence check unit 14 of the packet information collecting apparatus 10 then calculates the “memory access address” from the “statistical information base address” received from the pattern searching unit 12 and the “address offset” acquired from the table D 14a (step S1107) For example, the sequence check unit 14 of the packet information collecting apparatus 10 adds the “statistical information base address” of “0xA3000000” and the “address offset” of “0x0010” to calculate the “memory access address” of “0xA3000010”.

The sequence check unit 14 of the packet information collecting apparatus 10 stores the connection-basis information in the area of the statistical information memory B 15 specified by the “memory access address” (step S1108). For example, the sequence check unit 14 of the packet information collecting apparatus 10 stores the status information “SYN”, etc., as the connection-basis information in the area of the statistical information memory B 15 specified by the “memory access address” of “0xA3000010”.

However, if it is not determined that the table D 14a includes a corresponding connection (No at step S1105), the sequence check unit 14 of the packet information collecting apparatus 10 determines whether a connection of the reverse-direction packet exists (step S1111). For example, the table D 14a is searched again for the reverse-direction packet acquired by interchanging the “transmission source address” and the “transmission destination address” and interchanging the “transmission source port number” and the “transmission destination port number”. If it is determined that the reverse-direction packet does not exist (No at step S1111), the sequence check unit 14 of the packet information collecting apparatus 10 registers the connection into the table D 14a (step S1121) and goes to the above process of step S1106.

On the other hand, if it is determined that the reverse-direction packet exists (Yes at step S1111), the sequence check unit 14 of the packet information collecting apparatus 10 acquires the “address offset” corresponding to the connection from the table D 14a (step S1112), calculates the “memory access address” from the “statistical information base address” received from the pattern searching unit 12 and the “address offset” acquired from the table D 14a (step S1113), and stores and correlates the connection-basis information with the information of the forward-direction packet (step S1114).

As a result, the packet information collecting apparatus according to the first embodiment can collect the connection-basis information and can flexibly accommodate changes in the specification of information to be collected.

As described above, according to the first embodiment, with regard to a packet information collecting apparatus receiving a packet transmitted from a transmission source address to a transmission destination address to collect information about the packet, the packet information collecting apparatus receives and stores with a predetermined input unit connection-basis identification information for identifying a packet that is a target of information collection on the basis of a connection having an identified combination of a transmission source address and a transmission destination address; if a packet is received which is identified by the stored connection-basis identification information, the packet information collecting apparatus acquires information to store the acquired information into a predetermined storage unit on the basis of the connection identified by a combination of the transmission source address and the transmission destination address included in the packet; and therefore, the packet information collecting apparatus can collect the connection-basis information and can flexibly accommodate changes in the specification of information to be collected. That is, since information about a packet identified by the connection-basis identification information is stored on the basis of a connection having an identified combination of a transmission source address and a transmission destination address according to the technique of the present invention, the connection-basis information can be collected, and since only changes in the connection-basis identification information must be received from the predetermined input unit when changing the specification of information to be collected (changing a user policy) according to the technique of the present invention, the changes in the specification of information to be collected can flexibly be accommodated. For example, a user frequently accessing to a web server can be identified in a specific example.

According to the first embodiment, the predetermined storage unit is partitioned for each piece of information about a packet identified by any one or more of the transmission source address, the transmission destination address, the transmission source port number, and the transmission destination port number; the packet information collecting apparatus stores the information to be stored in the predetermined storage unit on the basis of the connection into the partitions identified by any one or more of the transmission source address, the transmission destination address, the transmission source port number, and the transmission destination port number of the packet that is a target of information collection in the storage unit; and therefore, the packet information collecting apparatus can store into the predetermined partitioned storage unit (e.g., a certain memory area (BANK)) the connection-basis information having the transmission source address, the transmission destination address, the transmission source port number, and the transmission destination port number, etc., identified. Traffic characteristics can be analyzed from the viewpoint of a network operation manager, etc., in accordance with the technique of partitioning the predetermined storage unit.

For example, when it is assumed that HTTP access to a web server normally is on the order of 30 concurrent connections on the basis of a connection, traffic characteristics can be analyzed from the viewpoint of a network operation manager, etc., in accordance with the technique of partitioning the predetermined storage unit such that the analysis can show that an abnormality may occur if the connection-basis information identified by a transmission destination address (web server) and a transmission destination port number (“80”) exceeds a capacity of a certain memory area (BANK) partitioned by 30.

According to the first embodiment, the packet information collecting apparatus stores into the predetermined storage unit and correlates with the connection-basis information identified by the combination of the transmission source address and the transmission destination address the information about a reverse-direction packet including the transmission source address as a transmission destination address and the transmission destination address as a transmission source address, i.e., the connection-basis information identified by the connection of the transmission source address and the transmission destination address included in the reverse-direction packet, and therefore, the connection-basis information can be collected from the viewpoint of bidirectional traffic characteristics.

According to the first embodiment, the packet information collecting apparatus acquires any one or more of statistical information about the packet, status information about the packet, and a sequence number of the packet as the information stored on the basis of the connection, and therefore, strict analysis can be performed with the collected connection-basis information.

In a specific example, for example, an analysis of security can be performed such that the analysis shows a possibility of the “SYN Flood attack” when the status information shows an abnormally large number of “SYN” connections, and for example, an abnormality of TCP sequence can be analyzed from the sequence numbers of the TCP (Transmission Control Protocol).

According to the first embodiment, the packet information collecting apparatus receives and stores with a predetermined input unit packet-basis identification information for identifying a packet that is a target of information collection on the basis of a packet having a transmission source address or transmission destination address identified; if a packet is received which is identified by the stored packet-basis identification information, the packet information collecting apparatus acquires information to store the acquired information into a predetermined storage unit on the basis of a packet identified by the transmission source address or transmission destination address included in the packet; and therefore, the packet information collecting apparatus can collect not only the connection-basis information but also the packet-basis information.

According to the first embodiment, the packet information collecting apparatus stores and correlates specification information specifying whether a target packet of the packet-basis information collection is defined as a target of the connection-basis information collection with the packet-basis identification information; when receiving a packet specified as the target of the connection-basis information collection by the stored specified information, the packet information collecting apparatus acquires and stores the information into the predetermined storage unit; and therefore, when collecting the packet-basis information, the packet information collecting apparatus can specify whether the connection-basis information is collected.

Although the packet information collecting apparatus according to the first embodiment has been described, the present invention may be implemented in various different forms other than the above embodiment. Therefore, various different embodiments will hereinafter be described as a packet information collecting apparatus according to a second embodiment of the present invention.

Although the packet information collecting apparatus has a configuration that can collect not only the connection-basis information but also the packet-basis information and that can specify whether the connection-basis information is collected when collecting the packet-basis information in the description of the first embodiment, this in not a limitation of the present invention, and the present invention is also applicable to a configuration that collects only the connection-basis information without collecting the packet-basis information and a configuration other than specifying whether the connection-basis information is collected when collecting the packet-basis information.

Although the storage unit is partitioned for each piece of information about the packet identified by any one or more of the transmission source address, the transmission destination address, the transmission source port number, and the transmission destination port number and the packet information collecting apparatus stores information into the partitions in the technique described in the first embodiment, this in not a limitation of the present invention, and the present invention is also applicable to a technique of using a non-partitioned storage unit and storing information into the non-partitioned storage unit.

Although the packet information collecting apparatus stores and correlates the connection-basis information of the reverse-direction packet with the connection-basis information of the forward-direction packet in the technique described in the first embodiment, this in not a limitation of the present invention, and the present invention is also applicable to a technique of storing the connection-basis information of the forward-direction packet and the connection-basis information of the reverse-direction packet without correlation.

Although the packet information collecting apparatus collects any one or more of statistical information about a packet, status information about a packet, and a sequence number of a packet in the technique described in the first embodiment, this in not a limitation of the present invention, and the packet information collecting apparatus may collect any specific types and contents of information as the connection-basis information.

Among the processes described in the embodiments, some or all of the manually performed processes (e.g., process executed by an operation manager, etc., when inputting the user policy into the table A 11a and the table C 12b with a keyboard, etc.) can automatically be executed with a known method. The process procedures, control procedures, specific names, various data, and information including parameters shown in the above description and drawings can be changed except otherwise specified.

The constituent elements of the shown apparatuses are functionally conceptual and do not necessarily have the shown physical configurations (e.g., FIG. 2). That is, specific forms of distribution/integration of the apparatuses are not limited to the shown forms and all or some of the forms can functionally and physically be distributed or integrated depending on various loads and usage statuses. All or any portion of the process functions executed in the apparatuses may be realized by the CPU and programs analyzed and executed with the CPU or realized as hardware by wired logic.

However, the various processes described in the first embodiment can be realized by executing preliminarily prepared programs with a computer such as a personal computer or workstation. Therefore, an example of a computer executing a packet information collecting program having the same function as the first embodiment will hereinafter be described with reference to FIG. 12.

As shown in FIG. 12, a computer 20 includes a cache 21, a RAM 22, an HDD 23, a ROM 24, and a CPU 25 connected by a bus 26. The ROM 24 preliminarily stores a pattern extracting program 24a, a pattern searching program 24b, and a sequence check program 24c carrying out the same function as the first embodiment.

The CPU 25 reads and executes the programs 24a, 24b, and 24c and the programs 24a, 24b, and 24c act as a pattern extracting process 25a, a pattern searching process 25b, and a sequence check process 25c as shown in FIG. 12. The processes 25a, 25b, and 25c correspond to the pattern extracting unit 11, the pattern searching unit 12, and the sequence check unit 14 shown in FIG. 2, respectively.

The HDD 23 is disposed with a table A 23a, a table B 23b, a table C 23c, a table D 23d, a statistical information memory A 23e, and a statistical information memory B 23f. The tables 23a, 23b, 23c, 23d, 23e, and 23f correspond to the table A 11a, the table B 12a, the table C 11b, the table D 14a, the statistical information memory A 13, and the statistical information memory B 15, respectively.

However, the programs 24a, 24b, and 24c are not necessarily stored in the ROM 24 and may be stored in, for example, a “portable physical medium”, such as a flexible disk (FD), CD-ROM, MO disk, DVD disk, magnetic optical disk, and IC card, inserted into the computer 20, a “fixed physical medium”, such as a hard disk drive (HDD), disposed externally or internally for the computer 20, or “another computer (or server)” connected to the computer 20 through public lines, the internet, LAN, WAN, etc., from which the computer 20 may read and execute the programs.

As described above, according to one aspect of the present invention, with regard to a packet information collecting apparatus receiving a packet transmitted from a transmission source address to a transmission destination address to collect information about the packet, the packet information collecting apparatus receives and stores with a predetermined input unit connection-basis identification information for identifying a packet that is a target of information collection on the basis of a connection having an identified combination of a transmission source address and a transmission destination address; if a packet is received which is identified by the stored connection-basis identification information, the packet information collecting apparatus acquires information to store the acquired information into a predetermined storage unit on the basis of the connection identified by a combination of the transmission source address and the transmission destination address included in the packet; and therefore, the packet information collecting apparatus can collect the connection-basis information and can flexibly accommodate changes in the specification of information to be collected. That is, since information about a packet identified by the connection-basis identification information is stored on the basis of a connection having an identified combination of a transmission source address and a transmission destination address according to the technique of the present invention, the connection-basis information can be collected, and since only changes in the connection-basis identification information must be received and stored with the predetermined input unit when changing the specification of information to be collected (changing a user policy) according to the technique of the present invention, the changes in the specification of information to be collected can flexibly be accommodated.

Furthermore, according to another aspect of the present invention, the predetermined storage unit is partitioned for each piece of information about a packet identified by any one or more of a transmission source address, a transmission destination address, a transmission source port number, and a transmission destination port number; the packet information collecting apparatus stores the information to be stored in the predetermined storage unit on the basis of the connection into the partitions identified by any one or more of the transmission source address, the transmission destination address, the transmission source port number, and the transmission destination port number of the packet that is a target of information collection in the storage unit; and therefore, the packet information collecting apparatus can store into the predetermined partitioned storage unit (e.g., a certain memory area (BANK)) the connection-basis information having the transmission source address, the transmission destination address, the transmission source port number, and the transmission destination port number, etc., identified. Traffic characteristics can be analyzed from the viewpoint of a network operation manager, etc., in accordance with the technique of partitioning the predetermined storage unit.

Moreover, according to still another aspect of the present invention, the packet information collecting apparatus stores into the predetermined storage unit and correlates with the connection-basis information identified by the combination of the transmission source address and the transmission destination address the information about a reverse-direction packet including the transmission source address as a transmission destination address and the transmission destination address as a transmission source address, i.e., the connection-basis information identified by the connection of the transmission source address and the transmission destination address included in the reverse-direction packet, and therefore, the connection-basis information can be collected from the viewpoint of bidirectional traffic characteristics.

Furthermore, according to still another aspect of the present invention, the packet information collecting apparatus acquires any one or more of statistical information about the packet, status information about the packet, and a sequence number of the packet as the information stored on the basis of the connection, and therefore, strict analysis can be performed with the collected connection-basis information.

Moreover, according to still another aspect of the present invention, the packet information collecting apparatus receives and stores with a predetermined input unit packet-basis identification information for identifying a packet that is a target of information collection on the basis of a packet having the transmission source address or the transmission destination address identified; if a packet is received which is identified by the stored packet-basis identification information, the packet information collecting apparatus acquires information to store the acquired information into a predetermined storage unit on the basis of a packet identified by the transmission source address or transmission destination address included in the packet; and therefore, the packet information collecting apparatus can collect not only the connection-basis information but also the packet-basis information.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A packet information collecting apparatus that receives a packet transmitted from a transmission source address to a transmission destination address and collects information on the packet, the packet information collecting apparatus comprising:
a connection-basis identification information storing unit that receives stores receives connection-basis identification information for identifying a packet for which the information is to be collected on the basis of a connection specifying a combination of the transmission source address and the transmission destination address from a predetermined input unit, and stores received connection-basis identification information; and
a connection-basis packet information collecting unit that acquires the information if a packet that is identified by the connection-basis identification information stored storing is received, and stores acquired information in a predetermined storage unit on the basis of the connection identified by a combination of the transmission source address and the transmission destination address included in the packet.

2. The packet information collecting apparatus of claim 1, wherein
the predetermined storage unit is partitioned for each piece of information on a packet identified by at least one of a transmission source address, a transmission destination address, a transmission source port number, and a transmission destination port number, and
the connection-basis packet information collecting unit stores the acquired information in a partition identified by at least one of the transmission source address, the transmission destination address, the transmission source port number, and the transmission destination port number of a packet for which the information is to be collected.

3. The packet information collecting apparatus of claim 1, wherein the connection-basis packet information collecting unit stores connection-basis information identified by the combination of the transmission source address and the transmission destination address in association with connection-basis information identified by a connection of a transmission source address as a transmission destination address included in a reverse-direction packet in which the transmission source address is included as the transmission destination address and the transmission destination address is included as the transmission source address.

4. The packet information collecting apparatus of claim 1, wherein the connection-basis packet information collecting unit acquires at least one of statistical information on the packet, status information on the packet, and a sequence number of the packet as the information to be stored on the basis of the connection.

5. The packet information collecting apparatus of claim 1, further comprising:
a packet-basis identification information storing unit that receives stores receives packet-basis identification information for identifying a packet for which the information is to be collected on the basis of a packet specifying the transmission source address or the transmission destination address from a predetermined input unit, and stores received packet-basis identification information; and
a packet-basis packet information collecting unit that acquires the information if a packet that is identified by the packet-basis identification information stored is received, and stores acquired information storing in a predetermined storage unit on the basis of the packet identified by a combination of the transmission source address and the transmission destination address included in the packet.

6. The packet information collecting apparatus of claim 5, wherein
the packet-basis identification information storing stores storing unit stores specification information specifying whether a packet for which the information is to be collected on the basis of the packet in association with the packet-basis identification information, and
when a packet specified as the target of connection-basis information collection by the specified information stored storing, the connection-basis packet information collecting unit acquires the information and stores acquired information in the predetermined storage unit.

7. A computer-readable recording medium that stores therein a computer program for receiving a packet transmitted from a transmission source address to a transmission destination address and collects information on the packet, the computer program causing a computer to execute:
connection-basis identification information storing including
receiving connection-basis identification information for identifying a packet for which the information is to be collected on the basis of a connection specifying a combination of the transmission source address and the transmission destination address from a predetermined input unit, and
storing received connection-basis identification information; and
connection-basis packet information collecting including
acquiring the information if a packet that is identified by the connection-basis identification information is received, and
storing acquired information in a predetermined storage unit on the basis of the connection identified by a combination of the transmission source address and the transmission destination address included in the packet.
